(19) United States
(12) Patent Application Publication
(10) Pub. No.: US 2024/0166385 A1
(43) Pub. Date: May 23, 2024

(54) ERGONOMIC UNCREWED AERIAL VEHICLE

(71) Applicant: Darkhive, Inc., San Antonio, TX (US)

(72) Inventors: Steven Turner, Nevada City, CA (US); John Goodson, San Antonio, TX (US); David Moroniti, Austin, TX (US)

(73) Assignee: Darkhive, Inc., San Antonio, TX (US)

(21) Appl. No.: 18/228,943

(22) Filed: Aug. 1, 2023

Related U.S. Application Data
(60) Provisional application No. 63/394,391, filed on Aug. 2, 2022.

(51) Int. Cl. B64U 30/299; B64U 30/26; B64U 50/30

(52) U.S. Cl. CPC B64U 30/299; B64U 30/26; B64U 50/30

(57) ABSTRACT

An uncrewed aerial vehicle (UAV) configured and operable for controllable flight, including autonomous flight. A generally planar body defining opposing front and back planar surfaces includes a plurality of circular duct openings provided in the planar body extending between the opposing front and back surfaces. A plurality of rotor guard assemblies are provided wherein each respective rotor guard assembly is configured for detachable engagement with a respective duct opening. A rotor is respectively rotatably mounted in each respective duct opening of the plurality of duct openings whereby each rotor is configured for providing propulsion of the UAV planar body. An electronic controller is operatively coupled to each rotor for controlling rotation of each rotor wherein the electronic controller is configured to enable flight of the UAV via a single hand-throw from a user operator of the UAV.

### CROSS REFERENCE TO RELATED APPLICATIONS

This application claims priority to U.S. Patent Application Ser. No. 63/394,391 filed Aug. 2, 2022 which is incorporated herein by reference in its entirety.

### BACKGROUND

### 1. Field

The disclosed embodiments generally relate to an Uncrewed Aerial Vehicle (UAV), and more particularly, to a lightweight and ergonomic UAV configured for defense and public safety applications.

### 2. Description of Related Art

Current small Uncrewed Aerial Vehicles (UAVs) are expensive, large, cumbersome to deploy, and dangerous to fly in environments where people or property may be harmed in the event of an unintended crash. Prior approaches such as AirSelfie™ have significant disadvantages in that they are not fully autonomous, have poor endurance, and are not rugged sufficiently for defense/public safety applications. Other current UAVs are either too expensive, large, and/or difficult to deploy and often requiring significant expertise to pilot.

While there currently are numerous commercially available UAVs for defense and public safety use applications, they are either: expensive; require a separate bulky ground control station; are not integrated with existing equipment users; are vulnerable to Electronic Warfare attacks; are not ergonomically designed for tactical deployment; and/or are not configured to be stack atop one another for rapid mass swam deployment.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, described is a lightweight (e.g., sub-250 gram) UAV having enclosed rotors, particularly configured and adapted for public safety and defense applications. The UAV of the illustrated embodiments is configured for reduced cost and is disposable in the event of a crash due to its reduced cost. Additionally, the UAV of the illustrated embodiments is configured to have a small footprint, while also being operable for rapid deployment via a single-handed launch/throw (which preferably provides a launch time of less than 10 seconds for the UAV). The UAV preferably has a fully enclosed ergonomic frame configured to be durable and which prevents user contact with its rotors via a configuration and construction that does not negatively impact its autonomous flight characteristics. The UAV preferably includes software configured and operable to enable it to operate with direct pilot interaction, and also autonomously without radio operation to a pilot.

It is to be appreciated that the UAV in accordance with the illustrated embodiments is a lightweight uncrewed flying system that can be deployed rapidly via throwing, and configured for providing autonomous flight for investigating the internals of a structure and/or providing remote awareness of a remote outdoor environment. The UAV of the illustrated embodiments preferably includes: an electronic controller configured for providing autonomous flights; a microcontroller for motor control; a GPS receiver for position data; and multiple camera sensors for providing visual data to a UAV operator as well as providing aid for GPS-denied navigation. Components of the UAV are preferably designed to minimize internal interference. The UAV has four (4) motors arranged preferably in an enclosed planar configured square frame for providing lift, wherein additional receivers and payloads may be mounted internally of the frame. Charging of the UAV is preferably accomplished via a charge port provided in its frame (e.g., a USB-C port) or via removable battery cells. It is to be appreciated that in accordance with certain illustrated embodiments, the UAV may be configured such that charging is provided when multiple UAVs are stacked atop of each other whereby the stacked UAVs are simultaneously charged via an external energy source, such as a container component for housing a plurality of stacked UAVs.

In another aspect of the illustrated embodiments, provided is an uncrewed aerial vehicle (UAV) configured and operable for controllable flight, including autonomous flight. The UAV includes a generally planar body defining opposing front and back planar surfaces defining a plurality of circular duct openings provided in the planar body extending between the opposing front and back surfaces. A plurality of rotor guard assemblies are provided wherein each respective rotor guard assembly is configured for detachable engagement with a respective duct opening. A rotor is respectively rotatably mounted in each respective duct opening of the plurality of duct openings whereby each rotor is configured for providing propulsion of the UAV planar body. An electronic controller is operatively coupled to each rotor for controlling rotation of each rotor wherein the electronic controller is configured to enable flight of the UAV via a single hand-throw from a user operator of the UAV.

### BRIEF DESCRIPTION OF THE DRAWINGS

So that those skilled in the art to which the subject disclosure appertains will readily understand how to snake and use the devices and methods of the subject disclosure without undue experimentation, preferred illustrated embodiments thereof will be described in detail herein below with reference to certain figures, wherein:

FIG. 1A illustrates a top oriented perspective view of an exemplary Uncrewed Aerial Vehicle (UAV) utilized with the illustrated embodiments;

FIG. 1B illustrates a planer view of a first side of the UAV of FIG. 1A;

FIG. 1C illustrates a planer view of a second side of the UAV of FIG. 1A;

FIG. 2 illustrates a planer top view of the UAV of FIG. 1A;

FIG. 3 illustrates an exploded perspective view of the UAV of FIG. 1A;

FIG. 4 illustrates a side oriented perspective view of the UAV of FIG. 1A;

FIGS. 5A-C illustrate thrust v. amps characteristics of the UAV of FIG. 1A with reference to a rotor assembly (FIG. 5A); and

FIG. 6 illustrates one or more internal and external components of the computing devices of FIG. 1 in accordance with an illustrative embodiment of the present invention.

### DETAILED DESCRIPTION OF CERTAIN EMBODIMENTS

Aspects of the disclosed embodiments are shown in the following description and related drawings directed to specific illustrated embodiments. Alternate preferred embodiments may be devised without departing from the scope of the illustrated. Additionally, well-known elements of the illustrated embodiments will not be described in detail or will be omitted so as not to obscure the relevant details of the illustrated embodiments. For instance, such UAV is shown and described in U.S. Pat. No. 10,310,617, incorporated herein by reference.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding either both of those included limits are also included in the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

Certain embodiments disclosed herein provide for Uncrewed Aerial Vehicles (UAVs), preferably configured for public safety detection purposes. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Turning now descriptively to the drawings, in which similar reference characters denote similar elements throughout the several views, described herein is a lightweight (e.g., sub-250 gram) UAV 100 having enclosed rotors, particularly adapted for public safety and defense applications. The UAV 100 of the illustrated embodiments is configured for reduced cost and thus is disposable in the event of a crash due to its reduced cost. It is preferably configured for rapid deployment (e.g., via throwing by a user) and for providing autonomous flight. Additionally, the UAV 100 of the illustrated embodiments is configured to have a small footprint, while also being operable for an aforesaid single-handed launch/throw. The UAV 100 preferably has a fully enclosed ergonomic frame configured to be durable and which prevents user contact with its rotors via a configuration and construction that does not negatively impact its autonomous flight characteristics. The UAV 100 preferably includes software configured and operable to enable it to operate with direct pilot interaction via a portable user controller device (e.g., a smart phone device), and also autonomously without radio operation with a pilot. Preferably, the UAV 100 is configured to be operable via a single hand-throw from a user enabling rapid deployment, recovery and autonomous stabilization of the UAV 100, which is accomplished via its unique design characteristics, as described below.

It is to be further appreciated and understood the UAV 100 is preferably designed to be stacked upon other like UAVs. Additionally, in accordance with certain illustrated embodiments, each UAV 100 may preferably be waterproof and buoyant.

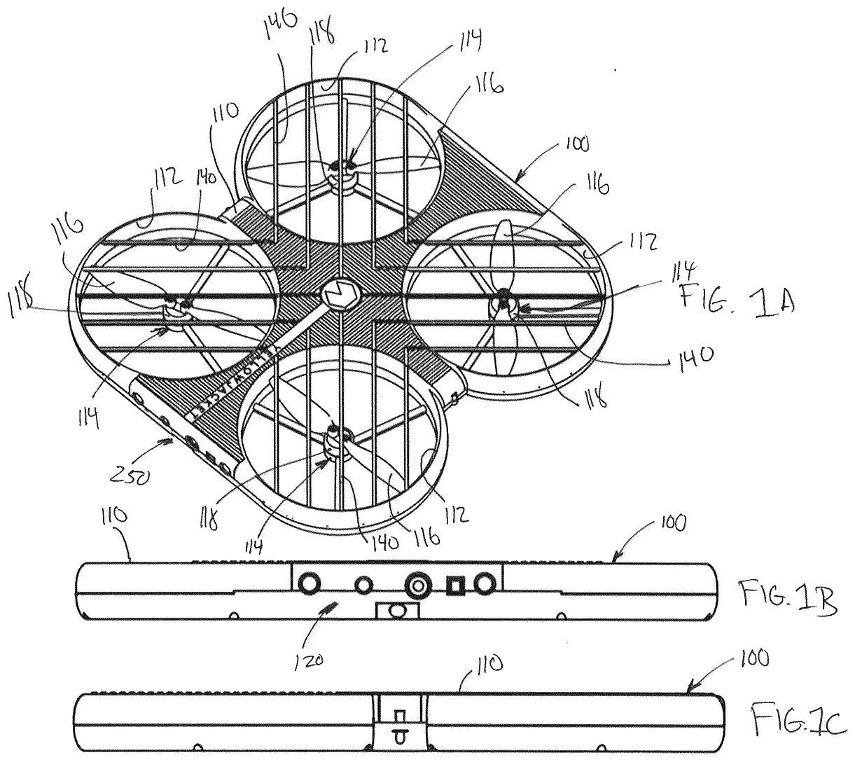

As described below with reference to FIG. 1, the UAV 100 in accordance with the illustrated embodiments preferably includes: an electronics controller configured for providing autonomous flight; a microcontroller for motor control purposes; a GPS receiver for position data; and multiple camera sensors for providing visual data to a UAV 100 operator as well as providing aid for GPS-denied navigation. Components of the UAV 100 are preferably designed to minimize internal interference.

As also further described below, charging of the UAV 100 is preferably accomplished via a charge port provided in its frame (e.g., a USB-C port) or via removable battery cells. It is to be appreciated that in accordance with certain illustrated embodiments, the UAV 100 may be configured such that charging is provided when multiple units are stacked atop of each other whereby the stacked UAVs 100 are simultaneously charged. In accordance with certain illustrated embodiments, the body 110 includes electrical contacts connected to a battery designed to electrically connect with electrical contacts positioned on external devices for enabling the UAV to charge when disposed in a containment device and/or stacked atop other UAVs.

Additionally, the UAV 100 preferably is compatible with current commercially available user communication devices (e.g., smart phones having either an iOS or Android operating system) which may include: a machine learning acceleration processor, microphones, and a network connection to external autonomous systems. A software module is preferably implemented on the aforesaid user communication device specifically configured to enable the user communication device to capture audio (e.g., voice), authenticate the audio (e.g., voice), and interpret speech into high-level commands for enabling operation of the UAV 100, whereby observations determined by the user communication device, via the implemented software module, are preferably relayed to a user of the communication device through internal speakers, external headset(s) and/or other external radio systems. The UAV 100 preferably includes software configured and operable to enable operation of the UAV 100 when requiring radio contact to an operator via a user communication device, or alternatively, autonomous operation of the UAV 100 not requiring radio connection to an operator, as shown and described in commonly assigned U.S. patent application Ser. No. 63/394,389, the contents of which are incorporated herein by reference.

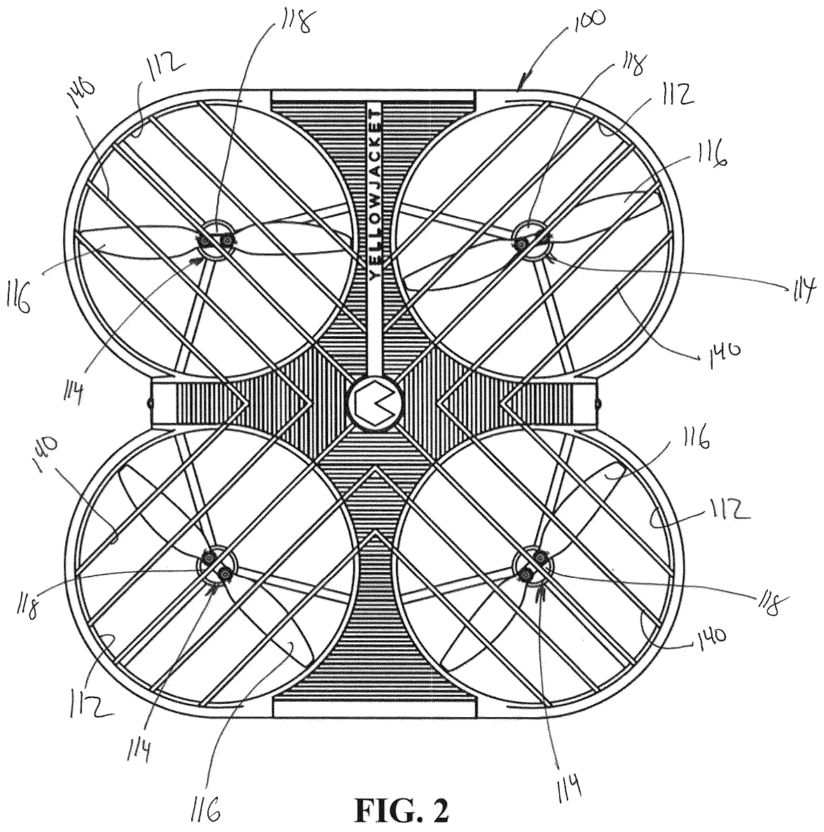

Turning now to FIGS. 1-4, depicted are various views of an exemplary UAV, designated generally by reference numeral 100, in accordance with the illustrated embodiments. Briefly, UAV 100 is preferably configured with a generally planar body 110 (as best shown in FIGS. 1B and 1C). The planar body 110 preferably enclosures a battery, which as described above may be removable from the body 110, capable of providing energy to the below described components of UAV 100. The body 110 preferably defines four duct openings 112. Additionally, and in accordance with certain illustrated embodiments, the body 110 may further include a modular internal radio port and/or at least one cavity portion configured to house one or more payloads.

A rotor assembly 114 is respectively provided in each duct opening 112, each including a rotating rotor blade 116 for providing propulsion/thrust of the UAV 100. An electric motor assembly 118 is respectively coupled to each rotor assembly 114, whereby each electric motor assembly 118 is electrically coupled to the battery. Each electric motor assembly 118 is preferably designed with minimized weight preferably via through cross-members preferably supporting a brushless motor and using rotor guards as structural support.

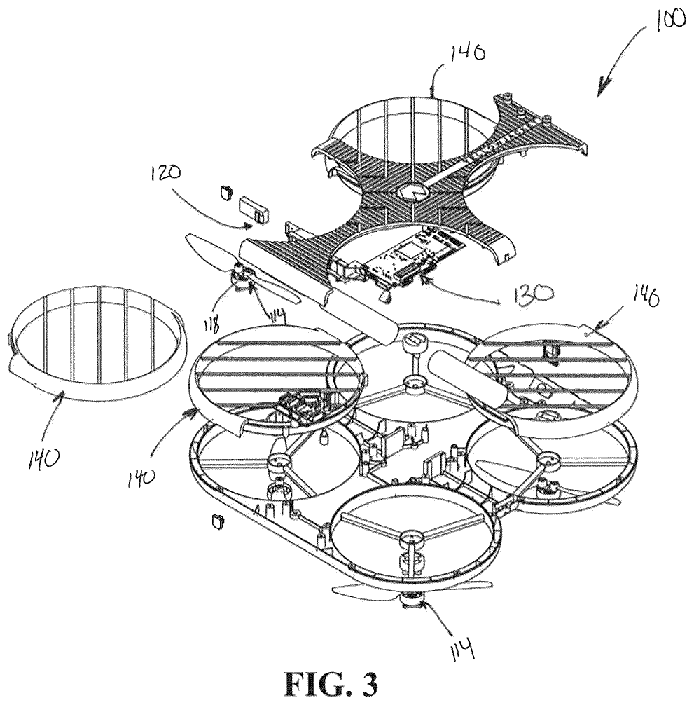

In accordance with the illustrated embodiments, UAV 100 preferably includes a an electronic controller 130 (FIG. 3) mounted within the body 110 and coupled to the battery, which is preferably configured to provide autonomous flight for the UAV 100, as well as user control via a coupled remote user device (e.g., a smart phone device). It is to be appreciated that controller 130 provides overall control of the electrical powered components of UAV 100. It is to be appreciated and understood that in accordance with certain illustrated embodiments, the UAV 100 is designed and configured to mitigate requirement for calibration prior to flight. For security purposes, the electrical controller 130 is preferably configured to delete a portion, or all, of the data stored locally on the UAV 100 in the event of a crash to prevent it from being subsequently accessed for nefarious purposes. Likewise for security purposes, at least a portion of software provided on the UAV 100 is preferably encrypted. A GPS component is also preferably provided in the body 110 connected to the battery and being configured for aiding navigation of the UAV 100, as is conventional.

Further a camera assembly 120 is also provided in a portion of the body 110 for capturing various images while the UAV 100 is in flight, as well as stationary on the ground. UAV 100 preferably includes a wireless communication interface 122 (FIG. 3) for providing overall control of the UAV 100, preferably via control of the motor assemblies 118, as well causing images captured by the camera assembly 120 to be transmitted to a user device communicatively coupled to the UAV 100. It is to be appreciated the camera assembly 120 may also be coupled to a memory component provided within the body 110 for storing captured images, which images may be autonomously captured, or captured upon command from an operator of the UAV 100. In accordance with the illustrated embodiments, the camera assembly 120 preferably includes one or more of: a plurality of stereo depth cameras; at least one thermal camera; at least one depth mapping sensor; and at least one obstacle tracking camera. The camera assembly 120 may further preferably include a single axis forward-facing gimbal. In accordance with the illustrated embodiments, it is to be understood and appreciated that the camera assembly 120 is preferably configured and operable to provide navigational aid to a UAV operator during occurrence of a GPS denied flight.

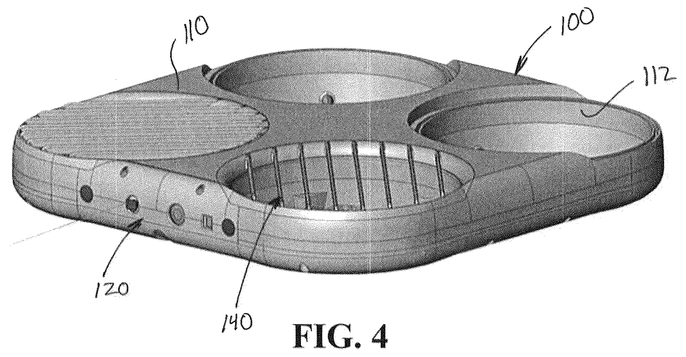

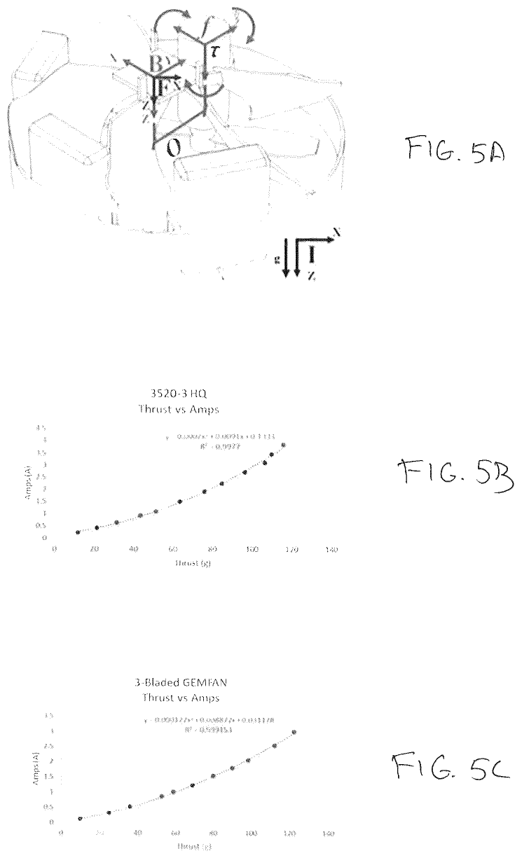

In accordance with the illustrated embodiments, each duct opening 112 is preferably provided with a removable rotor guard 140 respectively provided in each duct opening 112, preferably on opposing front and back surfaces of the body 110. Each rotor guard 140 is preferably configured and operably to minimize impact to airflow while the UAV 100 is in flight. Each rotor guard 140 is preferably removable from the body 110, preferably via a friction fit having a cooperating tab assembly provided on each rotor guard 140 and a corresponding location on the UAV body 110 for temporarily locking each rotor guard 140 to the body 110 once friction fitted therewithin. Additionally, other embodiments temporarily lock each rotor guard 140 into the body via user rotation of the rotor guard 140 to lock in and out of operation such that a first rotational direction detachably engages each rotor guard 140 to the planar body 110 and an opposing second rotational direction disengages each rotor guard 140 to the planar body 110. Preferably, each guard 140 has a “wing-like” configuration designed to minimize airflow drag. In accordance with the illustrated embodiments, the tolerances between each rotor guard 140 and rotor 160 are configured and operable to increase the thrust generated by a rotating rotor by reducing propeller tip vortices caused by the rotating rotor 116. For instance, as shown in FIG. 4, the two front rotors 116 are protected with guards 140 and the rear two ducts are open 112, whereby the guards 140 are designed to minimize the impact to airflow, preferably via their “wing-like” configuration profile that mitigates drag (e.g., similar to how standard wires or thin plastic guards typically interfere with airflow). Additionally, the UAV 100 is configured to have tight tolerances between the guard ducts 112 and rotors 116 for increasing the thrust generated by reducing prop tip vortices. As illustrated in FIGS. 5A-5C, qualitative testing of the UAV 100 clearly demonstrates nominal degradation of thrust generated by combining the removable guards with properly designed ducts, wherein 5B illustrates a 3-rotor No Duct No Guard configuration, and FIG. 5C illustrates a 3-rotor Duct and Guard configuration for the UAV 100. It is to be appreciate and understood, and in contrast to the configuration of UAV 100 of the illustrated embodiments, typical rotor guards of prior art UAV systems are not engineered to be removable and to increase efficiency by combining with tightly engineered ducts. Thus, it is to be appreciated that the UAV 100 in accordance with the illustrated embodiments provides near identical performance between the arrangements of FIGS. 5B and 5C despite the interference to airflow caused by prop guards 140. It is to be further appreciated that the weight tradeoff is negated as the structure is required for rigidity of the body 110 for the UAV 100.

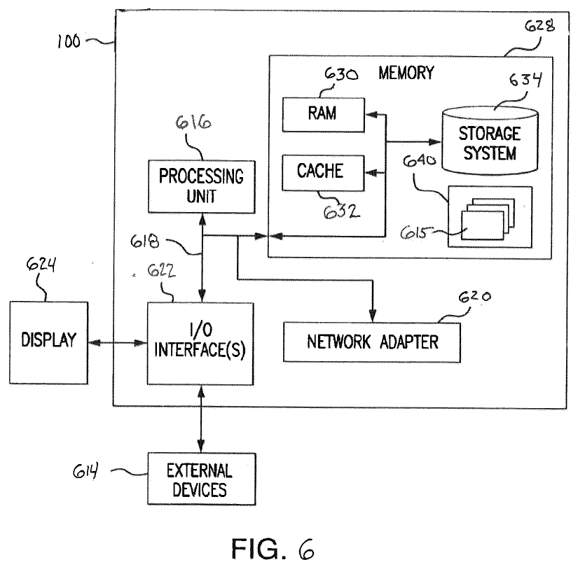

With the illustrated embodiments of FIG. 5 described above, FIG. 6 illustrates one or more internal and external components provided in UAV 100, in accordance with the above-described illustrated embodiments.

In particular, UAV 100 may be described in the general context of computer system-executable instructions, such as program modules, being executed by a computer system. Generally, program modules may include routines, programs, objects, components, logic, data structures, and so on that perform particular tasks or implement particular abstract data types. The UAV 100 may be operated in networked coupled data processing environments where tasks are performed by remote processing devices that are linked through a communications network.

The UAV 100 is generally shown in FIG. 6 in the form of general-purpose computing devices. The components of the UAV 100 may include, but are not limited to, one or more processors or processing units 616, a system memory 628, and a bus 618 that couples various system components including the system memory 628 to the processor 616.

The bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The UAV 100 typically may include a variety of computer system readable media. Such media may be any available media that is accessible by the UAV 100, and it may include both volatile and non-volatile media, removable and non-removable media.

The system memory 628 can include computer system readable media in the form of volatile memory, such as random access memory (RAM) 630 and/or cache memory 632. The UAV 100 may further include other removable/non-removable, volatile/non-volatile computer system storage media. By way of example only, a storage system 634 can be provided for reading from and writing to a non-removable, non-volatile memory. As will be further depicted and described below, the memory 628 may include at least one program product having a set (e.g., at least one) of program modules that are configured to carry out the functions of embodiments of the illustrated embodiments.

A program/utility 640, having a set (at least one) of program modules 465 that perform the disclosed methods may be stored in the memory 628 by way of example, and not limitation, as well as an operating system, one or more application programs, other program modules, and program data. Each of the operating system, one or more application programs, other program modules, and program data or some combination thereof, may include an implementation of a networking environment. Program modules 615 generally carry out the functions and/or methodologies of embodiments of the invention as described herein.

The UAV 100 may also communicate with one or more external devices 614 such as a keyboard, a pointing device, a display 624, etc.; one or more devices that enable UAV 100 and/or any devices (e.g., network card, modem, etc.) to communicate with one or more other computing devices. Such communication can occur via Input/Output (I/O) interfaces 622. Still yet, the UAV 100 can communicate with one or more networks such as a local area network (LAN), a general wide area network (WAN), and/or a public network (e.g., the Internet) via a network adapter 620. As depicted, the network adapter 620 communicates with the other components of the UAV 100 via the bus 418. It should be understood that although not shown, other hardware and/or software components could be used in conjunction with the u UAV 100. Examples, include, but are not limited to: microcode, device drivers, software-defined radios, redundant processing units, external disk drive arrays, tape drives, and data archival storage systems, etc.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. An uncrewed aerial vehicle (UAV) configured and operable for controllable flight, comprising:
a generally planar body defining opposing front and back planar surfaces;
a plurality of circular duct openings provided in the planar body extending between the opposing front and back surfaces; and
a plurality of rotor guard assemblies wherein a respective rotor guard assembly of the plurality of rotor guard assemblies is configured for detachable engagement with a respective duct opening of the plurality of duct openings.

2. The UAV as recited in claim 1, wherein each rotor guard assembly includes first and second rotor guards each configured to detachably engage with a respective duct opening of the plurality of duct openings whereby each said first rotor guard detachably engages with the front planar surface and each said second rotor guard detachably engages with the back planar surface of the planar housing relative to a said duct opening.

3. The UAV as recited in claim 2, wherein each first and second rotor guard of each rotor guard assembly is configured to have a wing-like profile for minimizing impact to airflow through a respective duct opening.

4. The UAV as recited in claim 3, wherein the plurality of duct openings include four separate duct openings whereby a respective duct opening is respectively provided in each of the four corners defined by the planar body.

5. The UAV as recited in claim 2, wherein each first and second rotor guard is configured to be removable from the planar body via user rotation of each first and second rotor guard relative to the planar body, such that a first rotational direction detachably engages each first and second rotor guard to the planar body and an opposing second rotational direction disengages each first and second rotor guard to the planar body.

6. The UAV as recited in claim 2, further including a plurality of rotors wherein a respective rotor of the plurality of rotors is respectively rotatably mounted in a respective duct opening of the plurality of duct openings whereby each said rotor is configured for providing propulsion of the UAV planar body.

7. The UAV as recited in claim 6, wherein tolerances between each said rotor guard assembly detachably engaged in a said respective duct opening and a respective rotor rotatably mounted in the duct opening is configured to increase thrust generated by a respective said rotor by reducing propeller tip vortices caused by the rotor when rotating.

8. The UAV as recited in claim 2, further including a plurality of electrical contacts being provided in the planar body such that when a plurality of UAV planar bodies are stacked atop one another, the electrical contacts provided on each stacked UAV electrically couple to the electrical contacts provided on an adjacent stacked UAV planar body.

9. The UAV as recited in claim 8, wherein a common power source is coupled to a plurality of UAV planar bodies stacked atop one another such that a battery component provided in each said stacked UAV planar body is caused to simultaneously charge relative to one another.

10. The UAV as recited in claim 6, wherein the planar body further includes:
a battery source;
a plurality of electric motor assemblies each coupled to the battery source, wherein a respective electric motor assembly is respectively coupled to a said respective rotor;
an electronic controller coupled to the battery and each of the plurality of electric motor assemblies for causing controllable rotation of each said rotor;
a camera assembly coupled to the electronic controller; and
a wireless communication interface coupled to the electronic controller for providing control signals to the electronic controller for controlling operation of the plurality of electric motor assemblies and the camera assembly wherein the wireless communication interface is configured to receive wireless control signals from a remote user portable computer device.

11. The UAV as recited in claim 10, wherein the electronic controller is configured to enable flight of the UAV via a single hand-throw from a user operator of the UAV.

12. The UAV as recited in claim 10, wherein the electronic controller is configured to automatically delete at least a portion of electronic data stored in memory coupled to the electronic controller upon occurrence of an unintended landing of the UAV.

13. An uncrewed aerial vehicle (UAV) configured and operable for controllable flight, comprising:
a generally planar body defining opposing front and back planar surfaces;
a plurality of circular duct openings provided in the planar body extending between the opposing front and back surfaces;
a plurality of rotor guard assemblies wherein a respective rotor guard assembly of the plurality of rotor guard assemblies is configured for detachable engagement with a respective duct opening of the plurality of duct openings;
a plurality of rotors wherein a respective rotor of the plurality of rotors is respectively rotatably mounted in a respective duct opening of the plurality of duct openings whereby each said rotor is configured for providing propulsion of the UAV planar body; and
an electronic controller operatively coupled to each said plurality of rotors for controlling rotation of each said rotor wherein the electronic controller is configured to enable flight of the UAV via a single hand-throw from a user operator of the UAV.

14. The UAV as recited in claim 13, wherein the electronic controller is configured to automatically delete at least a portion of electronic data stored in memory coupled to the electronic controller upon occurrence of an unintended landing of the UAV.

15. The UAV as recited in claim 13, wherein each rotor guard assembly includes first and second rotor guards each configured to detachably engage with a respective duct opening of the plurality of duct openings whereby each said first rotor guard detachably engages with the front planar surface and each said second rotor guard detachably engages with the back planar surface of the planar housing relative to a said duct opening.

16. The UAV as recited in claim 15, wherein each first and second rotor guard of each rotor guard assembly is configured to have a wing-like profile for minimizing impact to airflow through a respective duct opening.

17. The UAV as recited in claim 16, wherein each first and second rotor guard is configured to be removable from the planar body via user rotation of each first and second rotor guard relative to the planar body, such that a first rotational direction detachably engages each first and second rotor to the planar body and an opposing second rotational direction disengages each first and second rotor to the planar body.

18. The UAV as recited in claim 17, wherein tolerances between each said rotor guard assembly detachably engaged in a said respective duct opening and a respective rotor rotatably mounted in the duct opening is configured to increase thrust generated by a respective said rotor by reducing propeller tip vortices caused by the rotor when rotating.

19. The UAV as recited in claim 18, further including a plurality of electrical contacts being provided in the planar body such that when a plurality of UAV planar bodies are stacked atop one another, the electrical contacts provided on each stacked UAV electrically couple to the electrical contacts provided on an adjacent stacked UAV planar body.

20. The UAV as recited in claim 19, wherein a common power source is coupled to a plurality of UAV planar bodies stacked atop one another such that a battery component provided in each said stacked UAV planar body is caused to simultaneously charge relative to one another.
